(19) United States
(12) Patent Application Publication
(10) Pub. No.: US 2022/0327597 A1
(43) Pub. Date: Oct. 13, 2022

(54) SYSTEMS AND METHODS FOR QUOTING AND RECOMMENDING CONNECTIVITY SERVICES

(71) Applicant: AT&T Intellectual Property I, L.P., Atlanta, GA (US)

(72) Inventors: Stephen Griesmer, Westfield, NJ (US); Charles Diener, Atlanta, GA (US)

(21) Appl. No.: 17/229,504

(22) Filed: Apr. 13, 2021

(51) Int. Cl. G06Q 30/06; G06N 20/00

(52) U.S. Cl. CPC G06Q 30/0631; G06N 20/00; G06Q 30/0633

(57) ABSTRACT

A system can determine optimal service and product solutions from a variety of providers. The system can receive customer requests or requirements and determine current customer services or equipment, if any. The system can determine an inventory of solutions and rank such solutions according to one or more criterion using a ranking model. The system can compare existing customer service or equipment, if any, with available services or equipment that satisfy the customer requests or requirements and determine a recommendation for service(s) or equipment for the customer.

### TECHNICAL FIELD

The disclosed subject matter relates to connectivity services, and more particularly to automated connectivity product or service recommendations.

### BACKGROUND

Ordering even the simplest of business telecommunications products and/or services can be extraordinarily complex and opaque. Selected options and the configuration of a respective network can impact choices of technologies, services, and cost. Determining the best deal can be exceedingly difficult, especially when balancing competing interests, such as cost and quality. Additionally, business connectivity services are becoming increasingly commoditized in that competing products or services can be available from multiple providers. In this regard, an end-to-end view across providers is unavailable, and as a result, traffic cannot be easily switched across providers.

### BRIEF DESCRIPTION OF DRAWINGS

FIG. 1 is a block diagram of an exemplary system in accordance with one or more embodiments described herein.

FIG. 2 is a block diagram of an exemplary system in accordance with one or more embodiments described herein.

FIG. 3 represents exemplary recommendations for a service package in accordance with one or more embodiments described herein.

FIG. 4 is a flowchart of an example method for generating a product/service recommendation in accordance with one or more embodiments described herein.

FIG. 5 is a flowchart of an example method for generating a product/service recommendation in accordance with one or more embodiments described herein.

FIG. 6 is a flowchart of an example method for ordering a product/service in accordance with one or more embodiments described herein.

FIG. 7 is a block flow diagram for a process for generating a product/service recommendation in accordance with one or more embodiments described herein.

FIG. 8 is a block flow diagram for a process for generating a product/service recommendation in accordance with one or more embodiments described herein.

FIG. 9 is a block flow diagram for a process for generating a product/service recommendation in accordance with one or more embodiments described herein.

FIG. 10 is an example, non-limiting computing environment in which one or more embodiments described herein can be implemented.

FIG. 11 is an example, non-limiting networking environment in which one or more embodiments described herein can be implemented.

### DETAILED DESCRIPTION

The subject disclosure is now described with reference to the drawings, wherein like reference numerals are used to refer to like elements throughout. In the following description, for purposes of explanation, numerous specific details are set forth in order to provide a thorough understanding of the subject disclosure. It may be evident, however, that the subject disclosure may be practiced without these specific details. In other instances, well-known structures and devices are shown in block diagram form in order to facilitate describing the subject disclosure.

According to an embodiment, network equipment can comprise: a processor, and a memory that stores executable instructions that, when executed by the processor, facilitate performance of operations, comprising: receiving, from a customer device based on customer input associated with a customer identity, a group of requests for a requested telecommunication system to be implemented at a customer site associated with the customer identity, based on the customer input, determining whether the customer site comprises a first component that is able to be used at the customer site in fulfillment of a first request of the group of requests, wherein the first component is represented in component inventory information that is stored in a component inventory data store, wherein the component inventory information represents components associated with different component provider identities of different component providers, wherein the first component is associated with a first component provider identity of the different component provider identities, wherein a model of the components represented in the component inventory information has been generated based on machine learning applied to past performance information representative of past performances of the components at other customer sites other than the customer site in fulfillment of other requests other than the group of requests, in response to the customer site being determined to comprise the first component and based on a result of an analysis of the model indicating, according to a defined ranking criterion, that a first rank of the first component in the fulfillment of the first request is greater than other ranks of other components of the components other than the first component that are able to fulfill the first request, selecting the first component for the fulfillment of the first request, determining, based on the model and the component inventory information, a second component associated with a second component provider identity of the different component provider identities and a third component of the components associated with a third component provider identity of the different component provider identities for the requested telecommunication system, wherein the second component and the third component are able to be used at the customer site in fulfillment of a second request of the group of requests, and based on the result of the analysis of the model indicating, according to the defined ranking criterion, that a second rank of the second component in the fulfillment of the second request is greater than a third rank of the third component, generating a service package recommendation to be sent to the customer device, wherein the service package recommendation comprises a recommendation for using the first component to fulfill the first request, a recommendation for the second component to fulfill the second request, and a recommendation for service provider to facilitate service for the first component and the second component determined using a model of service providers generated based on machine learning applied to past service provider performance information representative of past performances of service providers.

It is noted that in some embodiments, the above operations can further comprise receiving the customer input via a user interface rendered at the customer device associated with the customer identity. Additionally, the above operations can further comprise sending the service package recommendation to the customer device, the service package recommendation comprising: first component information representative of the first component, the first rank associated with the first component, second component information representative of the second component, the second rank associated with the second component, third component information representative of the third component, the third rank associated with the third component, a recommendation to use the first component for the first request and the second component for the second request.

In some embodiments, operations can further comprise determining a template for the components stored in the component inventory data store, and prior to receiving the customer input, sending information to the customer device for presentation of the template via the user interface.

It is noted that the group of requests can comprise a location of the customer site. In some embodiments, the second component and the third component can be determined to be available to be provided at the location.

In one or more embodiments, operations can comprise determining, using the model, weights for the group of requests, wherein the first rank, the second rank, and the third rank are based on respective weights, of the weights, for the first request and the second request.

It is noted that the customer device associated with the customer identity can be a first customer device associated with a first customer identity, wherein the group of requests is a first group of requests, and the operations can further comprise: after implementation of the second component at the customer site, receiving performance information relating to a performance of the second component at the customer site, and updating the model of the components based on the performance information resulting in an updated model to be used for future analysis of a second group of requests received in the future from a second customer device associated with a second customer identity different than the first customer identity. In one or more embodiments, the performance information can comprise stability information representative of a stability associated with the implementation of the second component as compared to stabilities associated with prior implementations of the second component represented in the past performance information. In additional embodiments, the performance information can comprise on-time information representative of an amount of time from an order of the implementation of the second component to completion of the implementation of the second component at the customer site as compared to previous amounts of time from past orders of implementations of the second component to completions of the implementations of the second component represented in the past performance information. In further embodiments, the performance information can comprise bandwidth information representative of a bandwidth resulting from the implementation of the second component as compared to bandwidths resulting from prior implementations of the second component represented in the past performance information.

In another embodiment, a non-transitory machine-readable medium can comprise executable instructions that, when executed by a processor, facilitate performance of operations, comprising: receiving, from a customer device based on customer input associated with a customer identity, a group of requests for a requested telecommunication system to be implemented at a customer site associated with the customer identity, based on the customer input, determining whether the customer site comprises a first component that is able to be used at the customer site in fulfillment of a request of the group of requests, wherein the first component is represented in component inventory information that is stored in a component inventory data store, wherein the component inventory information represents components associated with different component provider identities of different component providers, wherein the first component is associated with a first component provider identity of the different component provider identities, wherein a model of the components represented in the component inventory information has been generated based on machine learning applied to past performance information representative of past performances of the components at other customer sites other than the customer site in fulfillment of other requests other than the group of requests, determining a second component, associated with a second component provider identity of the different component provider identities and represented in the component inventory information, that is not already implemented at the customer site and is able to be used at the customer site in the fulfillment of the request, determining, based on a result of an analysis of the model and the component inventory information and according to a defined ranking criterion, that a second rank of the second component in the fulfillment of the request is greater than a first rank of the first component, and generating recommendation information to be sent to the customer device, wherein the recommendation information comprises a service package for use at the customer site, wherein the service package comprises the second component and a highest-ranking service provider determined using the model according to a service provider ranking criterion and associated with the second component.

In various embodiments, the operations can further comprise after implementation of the second component at the customer site, receiving performance information relating to a performance of the second component at the customer site, and updating the model of the components based on the performance information resulting in an updated model to be used for future analysis of groups of requests received in the future from different customer devices associated with different customer identities other than the customer identity.

In one or more embodiments, the performance information can comprise customer opinion information representative of an opinion, associated with the customer identity, about the implementation of the second component at the customer site, and the operations can further comprise based on the customer opinion information, determining a numerical feedback score corresponding to the customer opinion information comprising using an artificial intelligence analysis to convert the customer opinion information to the numerical feedback score, wherein updating the model of the components comprises updating the model of the components based on the numerical feedback score.

To the accomplishment of the foregoing and related ends, the disclosed subject matter, then, comprises one or more of the features hereinafter more fully described. The following description and the annexed drawings set forth in detail certain illustrative aspects of the subject matter. However, these aspects are indicative of but a few of the various ways in which the principles of the subject matter can be employed. Other aspects, advantages, and novel features of the disclosed subject matter will become apparent from the following detailed description when considered in conjunction with the provided drawings.

In yet another embodiment, a method can comprise receiving, by network equipment comprising a processor from a customer device based on customer input associated with a customer identity, a group of requests for a requested telecommunication system to be implemented at a customer site associated with the customer identity, based on the customer input, determining, by the network equipment, whether the customer site comprises any component that is able to be used at the customer site in fulfillment of a request of the group of requests, in response to a determination that the customer site does not comprise any component that is able to be used at the customer site in fulfillment of the request, determining, by the network equipment based on a model of components represented in component inventory information that is stored in a component inventory data store and is generated based on machine learning applied to past performance information representative of past performances of the components at other customer sites other than the customer site in fulfillment of other requests other than the group of requests, a first component associated with a first component provider identity of component provider identities represented in the component inventory data store and a second component associated with a second component provider identity of the component provider identities, wherein the first component and the second component are determined to be able to be used at the customer site in fulfillment of the request, and wherein the component inventory information represents components associated with the component provider identities of different component providers, based on a result of a first analysis of the model indicating, according to a defined component ranking criterion, that a first component rank of the first component in the fulfillment of the request is greater than a second component rank of the second component, generating, by the network equipment, recommendation information to be sent to the customer device comprising component information about the first component and the second component and a recommendation to use the first component to satisfy the request, generating, by the network equipment, a recommendation for a bundle, wherein the bundle comprises the recommendation to use the first component in satisfaction of the request and service provider associated with the first component, wherein the service provider is determined based on a second analysis of the model indicating, according to a defined service ranking criterion, that a service rank of a service provider identity of the service provider is higher than service ranks of other service provider identities of other service providers.

In some embodiments, a component of the components can comprise a software defined wide area network.

It should be appreciated that additional manifestations, configurations, implementations, protocols, etc. can be utilized in connection with the following components described herein or different/additional components as would be appreciated by one skilled in the art.

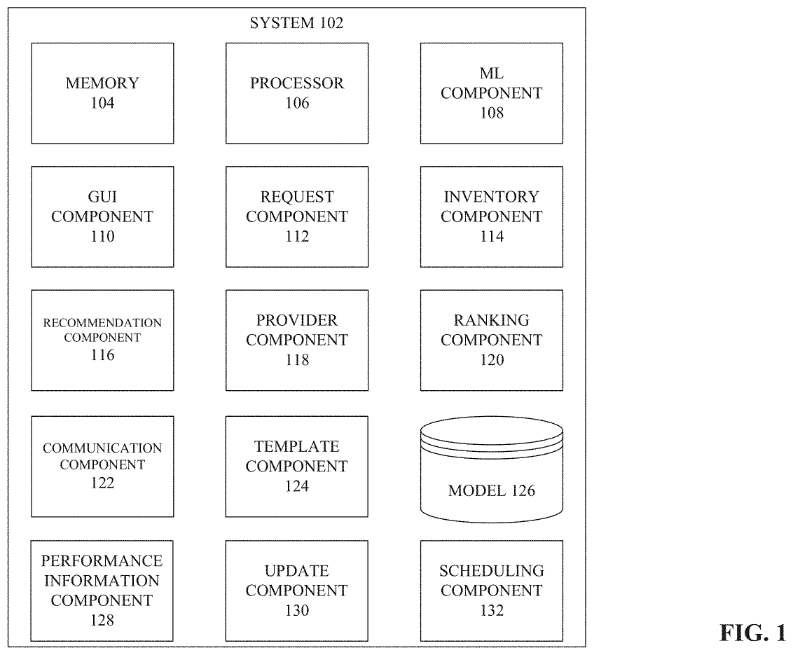

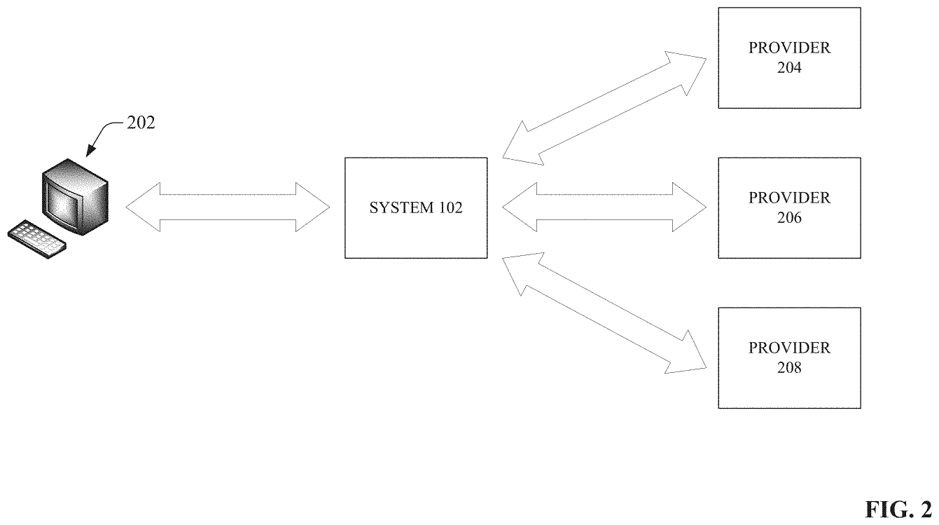

Turning now to FIG. 1, there is illustrated an example, non-limiting system 102 in accordance with one or more embodiments herein. System 102 can be configured to perform various operations relating to quoting and/or recommending of connectivity equipment and/or services, such as business connectivity services. The system 102 can comprise one or more of a variety of components, such as memory 104, processor 106, machine learning (ML) component 108, graphical user interface (GUI) component 110, request component 112, inventory component 114, recommendation component 116, provider component 118, ranking component 120, communication component 122, template component 124, model 126, performance information component 128, update component 130, and/or scheduling component 132. FIG. 2 illustrates the system 102 as communicatively coupled to a user equipment 202 (e.g., a customer device) and various providers 204, 206, and 208.

In various embodiments, one or more of the memory 104, processor 106, ML component 108, GUI component 110, request component 112, inventory component 114, recommendation component 116, provider component 118, ranking component 120, communication component 122, template component 124, model 126, performance information component 128, update component 130, and/or scheduling component 132, user equipment 202, provider 204, provider 206, and/or provider 208 can be communicatively or operably coupled (e.g., over a bus or wireless network) to one another to perform one or more functions of the system 102.

According to an embodiment, the system 102 can generate a GUI, for instance, using the GUI component 110. In an embodiment, such a GUI can be provided on a website communicatively coupled to the system 102. In various embodiments, the GUI can provide a template (e.g., generated using the template component 124) corresponding to options and/or fields to be completed (e.g., filled) by a user (e.g., with a user equipment 202. It is noted that the communication component 122 can be utilized to communicatively couple the system 102, for instance, to a network. In this regard, the system 102 can communicate with a user equipment 202 using the communication component 122. It is noted that the user equipment 202 can comprise, for instance, a computer, mobile device such as a smartphone, a tablet, laptop, desktop, or other user equipment (e.g., possessing internet access). In various embodiments, the GUI component 110 can generate a user interface (UI) on a website, as made accessible to the user equipment 202 using the communication component 122.

In various embodiments, the communication component 122 is operable (e.g., by a provider component 118) to facilitate communication between providers (e.g., providers 204, 206, 208, or other providers) registered with the system 102. In this regard, the provider component 118 can determine and/or store information associated with various provider entities (e.g., providers 204, 206, or 208), such as services offered, equipment offered, associated costs, locations services, respective estimated times to implement respective equipment or services, pricing tiers, promotions, compatibility information, or other information associated with the provider entities.

According to an embodiment, the communication component 122 can possess the hardware required to implement a variety of communication protocols (e.g., infrared (“IR”), shortwave transmission, near-field communication (“NFC”), Bluetooth, Wi-Fi, long-term evolution (“LTE”), 3G, 4G, 5G, global system for mobile communications (“GSM”), code-division multiple access (“CDMA”), satellite, visual cues, radio waves, etc.)

According to another embodiment, the request component 112 can be configured to request an input from the user equipment 202 or receive a request from the user equipment 202. In various embodiments, the request component 112 can receive a group of requests for a requested telecommunication system to be implemented at a customer site. The group of requests can comprise one or more various requirements, preferences, importance weights, equipment, service needs, or other suitable information. According to an embodiment, the requested telecommunication system and/or group of requests can be associated with a location of a customer site. It is noted that a customer site can comprise a single geographic area (e.g., a building) or a campus. It is also noted that a customer site can comprise multiple geographic locations, for instance, for a telecommunication system for an entity with multiple locations, such as a regional, national, or international presence. According to an example, a customer can possess fifty office locations scattered around various geographical regions. A corresponding group of requests can comprise a request for a software-defined wide area network which can be software-controlled and can further comprise links to all fifty locations to have links to a central office site and/or have links out directly to internet. A request can comprise, for example, desired gigabits of bandwidth, quantity of locations, types of services such as wireline, wireless, internet protocol (e.g., over cellular), virtual private network (VPN), software-defined networking in a wide area network (SD-WAN), and/or desired price.

The system 102 can determine whether a customer site already comprises equipment or services that can be used as the customer's site in order to fulfill a request (e.g., of a group of requests). In this regard, the request component 112 can receive information regarding existing components, equipment or services at a customer site, and the inventory component 114 can store information associated with the existing components, equipment or services (e.g., in an inventory database or data store). It is noted that the inventory component 114 can also store other component information, equipment information or service information and associated availability information for providers (e.g., provider entities) associated with the system 102 or registered with the system 102. In this regard, the inventory component 114 can store software-based components, equipment, and/or services, or information (e.g., availability information) concerning physical hardware or equipment (e.g., that can be provided at a customer site). Such provider entities can comprise one or more entities that operates or owns the system 102. Such provider entities can also comprise competitor provider entities registered with or otherwise authorized to use or communicate with the system 102. It is noted that the inventory component 114 or the system 102 can be distributed (e.g., used via a cloud-based platform). Access to the inventory component 114 or the system 102 can be facilitated by network software or customer device software, or a combination thereof. In this regard, service packages described herein likewise can be stored on customer device storage and/or in a cloud-based platform or otherwise externally stored (e.g., with provider entity or a third-party vendor), or a combination thereof.

According to an embodiment, a model (e.g., model 126) can be generated which can correspond to provider entities, components, products, equipment, and/or services associated with the inventory component 114 or otherwise stored in an inventory database or data store (e.g., of the inventory component 114 or system 102). According to an embodiment, the model 126 can be generated based on machine learning (e.g., by ML component 108). In this regard, such machine learning can be applied to past performance information representative of past performance(s) of various components utilized or otherwise implemented at other customer sites (e.g., for different customers or a prior implementation with the same customer) in fulfillment of other requests other than the instant request or group of requests. It is noted that the performance information component 128 can obtain, determine, aggregate, or store such past performance information in addition to other tasks or functions.

According to an embodiment, the system 102 (e.g., using ranking component 120) can rank various provider entities, components, products, equipment, and/or services that are capable of satisfying requirements or needs associated with a request or the group of requests received by the request component 112, for instance, using the model 126 to develop ranks using the past performances and/or inventory component 114 comprising a database of available provider entities, components, products, equipment, and/or services. According to an example, a customer's existing components, equipment, etc. can outrank (e.g., rank higher than) other components or services that can satisfy a customer's request, requirements, or needs. In this example, a recommendation component 116 can generate a recommendation to maintain or keep the customer's existing equipment or services. It is noted that a group of requests can comprise multiple request. For instance, a group of requests can comprise a first request, a second request, a third request, fourth request, fifth request, and so on. Ranks/recommendations can be generated by the ranking component and/or recommendation component 116 for each request of a group of requests. In this regard, and according to an example, a customer's existing equipment can be optimal for fulfilling a customer's first request, and a different provider entity, component, product, equipment, and/or service can be optimal for fulfilling another request of a customer's group of requests. It is noted that ranking herein (e.g., by the ranking component 120) can be performed to a defined ranking criterion (e.g., using importance weights) and can be associated with various factors such as cost of component or service implementation, time of implementation, quality of provider, quality of equipment, quality of service, customer satisfaction information, past performance information). In this regard, the recommendation component 116 can generate a recommendation for a group of requests, the recommendation comprising different respective recommendations for each respective request of the group of requests. It is noted that the recommendation for the group of requests can comprise an overall service package recommendation. This service package recommendation can comprise a service provider for fulfillment of a request of the group of requests. The service package recommendation can additionally comprise a recommendation for a component for fulfillment of a request of the group of requests. It is noted that the service package can comprise one or more service providers for fulfillment of one or more requests of the group of requests. A single service provider can be recommended for satisfaction of multiple requests of the group of requests, or different service providers can be selected for satisfaction of various requests of the group of requests. According to an embodiment, the service package recommendation can always comprise at least one service provider recommendation. In an embodiment, the service package recommendation can comprise zero or more component recommendations. According to an example, a customer can reject an individual recommendation within a service package recommendation. In this regard, the recommendation component 116 can recommend an alternate solution (e.g., a second highest ranking component or service for fulfillment of the rejected recommendation of a request of a group of requests).

According to an embodiment, the system 102 can (e.g., using a communication component 122 and/or GUI component 110) facilitate input/output (I/O) with a user equipment (e.g., user equipment 202) in order to transmit and/or receive information between the system 102 and the user equipment 202. In this regard, customer input can be received by the system 102 via a user interface (e.g., as generated by the GUI component 110) rendered at the user equipment 202. According to an embodiment, the user equipment 202 (e.g., a customer device) can be associated with a customer identity of a respective customer. According to an example, the customer identity can be associated with a business or business identity associated with the customer site.

According to another embodiment, a system 102 (e.g., using template component 124) can determine a template for a component stored, for instance, in a data store associated with the inventory component 114. In this regard, prior to receiving customer input, the system 102 (e.g., using communication component 122, template component 124, and/or GUI component 110) send information to a customer device (e.g., user equipment 202) for presentation of the template via the customer device (e.g., user equipment 202). In one or more embodiments, a request or a group of requests herein can comprise a location (e.g., a geographic location) of a customer site or sites associated with a respective customer or user. In this regard, components or services herein can be determined (e.g., using the ranking component 120) to be available at the location or locations associated with the respective customer or user.

According to an embodiment, one or more weights (e.g., importance weights) for a group of requests can be determined (e.g., using the model 126 by the request component 112, ranking component 120, or a different component of system 102). According to an example, the ranking component 120 can determine weights associated with each request of a group of requests. Such weights can comprise weights associated with, for instance, cost, system stability (e.g., stability information), performance information, on-time information (e.g., on-time rating for implementation of a corresponding system or equipment), bandwidth information, or other weights. Performance information can comprise stability information representative of a stability associated with an implementation of a component or service as compared to stabilities associated with prior implementations of such components or services represented in past performance information. It is noted that performance information can comprise on-time information representative of an amount of time from an order of an implementation of a component or service to completion of the implementation at a customer site, as compared to previous amounts of time from past orders of implementations of corresponding, similar, or related components, equipment, or systems. In another embodiment, bandwidth information can be representative of a bandwidth resulting from an implementation of an equipment or service as compared to bandwidth resulting from prior implementations of such equipment or services represented in past performance information. It is also noted that such bandwidth information can comprise corresponding network throughput information and/or corresponding network latency information. Based on past performance information, respective ranks for solutions (e.g., component or service solutions) for each request of the group of requests can be generated (e.g., by the ranking component 120). It is noted that the ranking component can generate a rank for an overall service package, which can comprise sub-rankings for solutions to individual requests of a group of requests. In this regard, a highest-ranking service package can comprise a highest aggregated ranking for each fulfillment of a request of a group of requests.

According to an embodiment, the ranking component 120 can utilize the model 126 and inventory component 114 in order to evaluate historical orders that were provided for service and/or equipment requests similar to an instant request or group of requests. The ranking component 120 can utilize the model 126 to determine rankings for functional solutions to a customer's request. In this regard, the recommendation component 116 can generate a recommendation based on such rankings. It is noted that the ML component 108 can continuously update the model 126 in order to improve accuracy of the model 126. In other embodiments, the ML component 108 can determine an optimal solution (e.g., equipment and/or service) corresponding to a customer request.

According to an embodiment, performance information relating to a performance of a component or service implemented at a customer site can be received (e.g., by a performance information component using the communication component 122). The system 102 (e.g., with update component 130) can utilize such performance information to update the model 126 so that future analysis of requests groups of requests received in the future, for instance, from future or different customer devices associated with different customer identities (or the same customer or customer identity), can be ranked with increased accuracy. According to an embodiment, the ML component 108 can be utilized to leverage ML to update the model 126.

According to yet another embodiment, performance information herein can comprise customer opinion information representative of an opinion, associated with a customer identity, about an implementation of a component or service at a customer site. In this regard, the system 102 (e.g., using performance information component 128) can determine a numerical feedback score corresponding to the customer opinion information. In one or more embodiments, the ML component 108 can be utilized in order to perform an artificial intelligence analysis to convert customer opinion information to such a numerical feedback score. It is noted that, in this regard, the model 126 can be updated using such a numerical feedback score. It is also noted that in one or more embodiments, a component herein can comprise a software defined wide area network. In further embodiments, such performance information can comprise written or spoken opinion information. In this regard, the ML component 108 can analyze the written or spoken opinion information in order to convert the written or spoken opinion information into a numerical feedback score.

According to an embodiment, a scheduling component 132 can be utilized to schedule an appointment with one or more provider entities registered with the system 102. In this regard, the scheduling component 132 can be utilized in conjunction with the GUI component 110 to enable a user to schedule (e.g., using a user equipment 202) an appointment with a recommended provider entity (e.g., as recommended by the recommendation component 116) or a different provider entity (e.g., if a user ignores a recommendation by the system 102 and instead wishes to select a different available provider entity able to provide an equipment or service.). It is noted that the scheduling component 132 can be configured to schedule an appointment for an installation of a service or equipment with a provider for any provider associated with the system 102 or registered to use the system 102 or otherwise communicatively coupled to the system 102.

Various embodiments herein can employ artificial-intelligence or machine learning systems and techniques to facilitate learning user behavior, context-based scenarios, preferences, etc. in order to facilitate taking automated action with high degrees of confidence. Utility-based analysis can be utilized to factor benefit of taking an action against cost of taking an incorrect action. Probabilistic or statistical-based analyses can be employed in connection with the foregoing and/or the following.

It is noted that systems and/or associated controllers, servers, or ML components herein can comprise artificial intelligence component(s) which can employ an artificial intelligence (AI) model and/or ML or an ML model that can learn to perform the above or below described functions (e.g., via training using historical training data and/or feedback data).

In some embodiments, ML component 108 can comprise an AI and/or ML model that can be trained (e.g., via supervised and/or unsupervised techniques) to perform the above or below-described functions using historical training data comprising various context conditions that correspond to various management operations. In this example, such an AI and/or ML model can further learn (e.g., via supervised and/or unsupervised techniques) to perform the above or below-described functions using training data comprising feedback data, where such feedback data can be collected and/or stored (e.g., in memory) by an ML component 108. In this example, such feedback data can comprise the various instructions described above/below that can be input, for instance, to a system herein, over time in response to observed/stored context-based information.

AI/ML components herein can initiate an operation(s) associated with a based on a defined level of confidence determined using information (e.g., feedback data). For example, based on learning to perform such functions described above using feedback data, performance information, and/or past performance information herein, an ML component 108 herein can initiate an operation associated with generating a provider, component, or service recommendation if the ML component 108 or associated controller or processor determines, for instance, an optimal service, component, and/or service provider. In another example, based on learning to perform such functions described above using feedback data, performance information, and/or past performance information herein, an ML component 108 herein can initiate an operation associated with updating a model (e.g., model 126).

In an embodiment, the ML component 108 can perform a utility-based analysis that factors cost of initiating the above-described operations versus benefit. In this embodiment, an artificial intelligence component can use one or more additional context conditions to determine an optimal service, component, or service provider or to determine an update for a model 126.

To facilitate the above-described functions, an ML component herein can perform classifications, correlations, inferences, and/or expressions associated with principles of artificial intelligence. For instance, an ML component 108 can employ an automatic classification system and/or an automatic classification. In one example, the ML component 108 can employ a probabilistic and/or statistical-based analysis (e.g., factoring into the analysis utilities and costs) to learn and/or generate inferences. The ML component 108 can employ any suitable machine-learning based techniques, statistical-based techniques and/or probabilistic-based techniques. For example, the ML component 108 can employ expert systems, fuzzy logic, support vector machines (SVMs), Hidden Markov Models (HMMs), greedy search algorithms, rule-based systems, Bayesian models (e.g., Bayesian networks), neural networks, other non-linear training techniques, data fusion, utility-based analytical systems, systems employing Bayesian models, and/or the like. In another example, the ML component 108 can perform a set of machine-learning computations. For instance, the ML component 108 can perform a set of clustering machine learning computations, a set of logistic regression machine learning computations, a set of decision tree machine learning computations, a set of random forest machine learning computations, a set of regression tree machine learning computations, a set of least square machine learning computations, a set of instance-based machine learning computations, a set of regression machine learning computations, a set of support vector regression machine learning computations, a set of k-means machine learning computations, a set of spectral clustering machine learning computations, a set of rule learning machine learning computations, a set of Bayesian machine learning computations, a set of deep Boltzmann machine computations, a set of deep belief network computations, and/or a set of different machine learning computations.

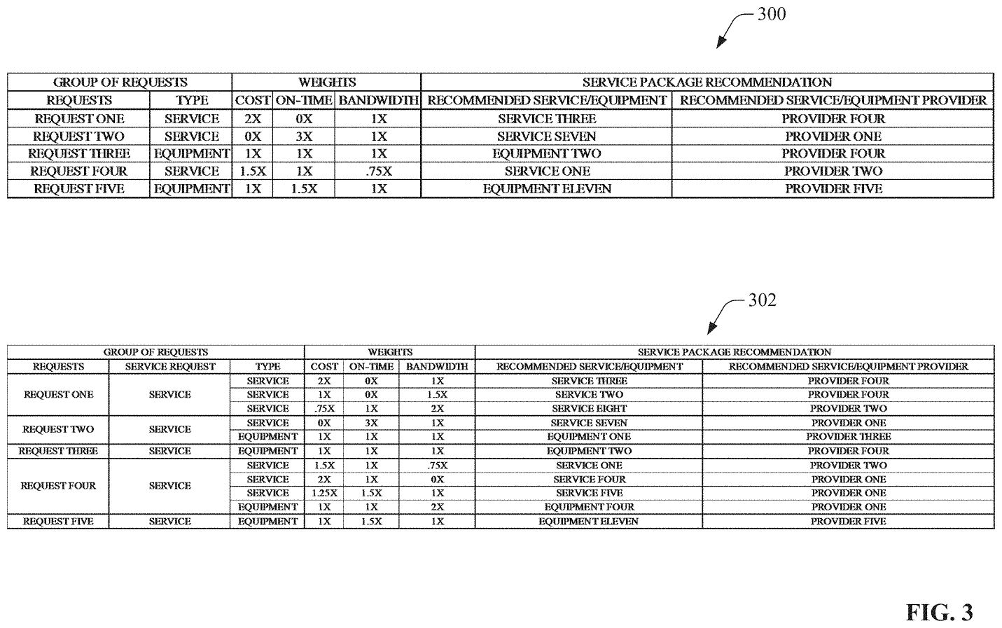

FIG. 3 represents charts 300 and 302 comprising exemplary recommendations for a service request package associated with a group of requests. In chart 300, a group of requests (requests one, request two, request three, request four, and request five). Here, each request is associated with a service or an equipment. Weights (e.g., cost, on-time, and bandwidth) can be utilized according to customer preferences associated with the requests and group of requests. Based on such weights, a recommendation for each request can be generated in which the recommendation corresponds to the equipment or service comprising the highest rating for that respective request (e.g., using a ranking component 120 and/or recommendation component 116). Additionally, a recommended provider entity for said recommended equipment or service can be determined (e.g., provider 204, provider 206, provider 208, etc. using a provider component 118). It is noted that an overall service package recommendation (e.g., as ranked and/or generated by the ranking component 120 or recommendation component 116) can comprise one or more recommendations for one or more services and/or components associated with requests of the group of requests. The chart 300 or information associated with the chart 300 can be sent to a customer or business associated with the group of requests (e.g., using a communication component 122 and/or GUI component 110). In one or more embodiments, ML component 108 can be leveraged to facilitate the foregoing.

In chart 302, it is noted that each request of a group of requests can comprise a request for a service, of which each service can be associated with multiple services and/or equipment. In this regard services described herein can comprise an aggregation of types of sub-services, sub-components, and/or sub-equipment. For instance, chart 302 depicts a group of requests (e.g., requests one-five). Each request of the group of requests can be associated with a service. Each such service can be associated with an equipment or a service (e.g., a sub-equipment or a sub-service). Weights (e.g., cost, on-time, and bandwidth) can be utilized according to customer preferences associated with the requests, service request, and/or group of requests. Based on such weights, a recommendation for each request or service can be generated in which the recommendation corresponds to the equipment or service (or sub-service or sub-equipment) comprising the highest rating for that respective request or service (e.g., using a ranking component 120 and/or recommendation component 116). Additionally, a recommended provider entity for said recommended equipment or service (or sub-service or sub-equipment) can be determined (e.g., provider 204, provider 206, provider 208, etc. using a provider component 118). Similarly, a request for a service can comprise an overall rating to be utilized in an overall service package recommendation. It is noted that an overall service package recommendation (e.g., as ranked and/or generated by the ranking component 120 or recommendation component 116) can comprise one or more recommendations for one or more services and/or equipment (and sub-equipment or sub-service) associated with requests of the group of requests. The chart 302 or information associated with the chart 302 can be sent to a customer or business associated with the group of requests (e.g., using a communication component 122 and/or GUI component 110). In one or more embodiments, ML component 108 can be leveraged to facilitate the foregoing. In this regard, the ML component 108 can determine how combinations of services and/or equipment are rated so that optimal services and/or equipment can be recommended to customers.

According to an example, a first component (e.g., an equipment or a service) can be determined to be able to fulfill a first request of a group of requests. In this non-limiting example, a rank associated with the first component can be greater than other ranks of other components (e.g., equipment or services) (that can also fulfill the first request). In this example, the first component can therefore be selected for fulfillment of the first request. Additionally, a second component and a third component can both be determined to be able to satisfy a second request of the group of requests. In this regard, a higher-ranking component (e.g., of a second rank associated with the second component and a third rank associated with the third component) can be recommended for fulfillment of the second request. It is noted that this is a non-limiting example and countless combinations of components and associated ranks can be analyzed and/or compared in order to generate a recommendation for a fulfillment of a respective request. In one or more embodiments, recommendation information comprising the various components (e.g., first component, second component, and third component), respective component ranks, and/or recommendation(s) corresponding to the highest-ranking components can be sent to a customer device (e.g., user equipment 202). In another example, a fourth component can outrank the first component for fulfillment of the first request. In this regard, the fourth component can be recommended for fulfillment of the first request rather than the first component as in the previous example.

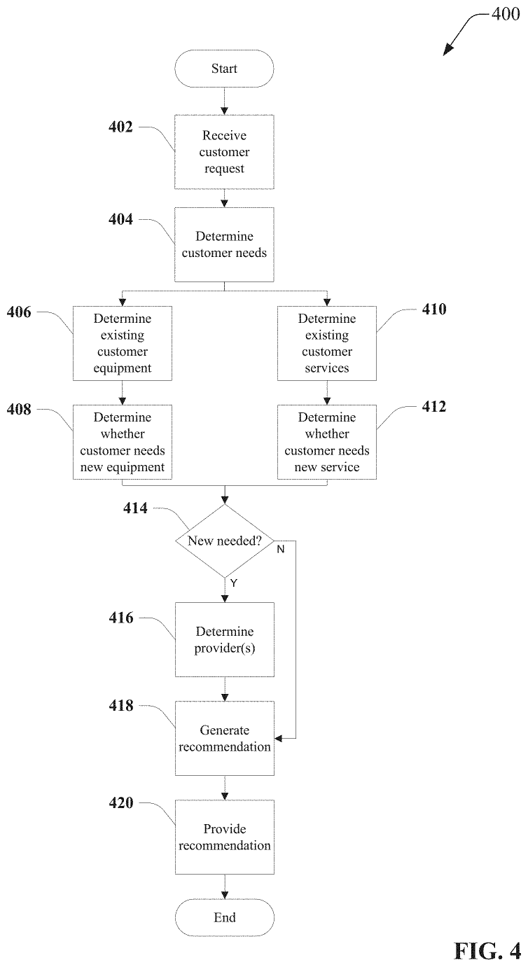

Turning now to FIG. 4, there is illustrated a flow chart of a process 400 for providing a recommendation for an equipment and/or service in accordance with one or more embodiments described herein. At 402, a system (e.g., system 102) can receive a customer request, which can comprise a group of requests or be one of a group of requests. At 402, the system can determine customer needs (e.g., various component such as equipment and/or services) based on the customer request. At 406, the system can determine existing customer equipment based on the customer request. It is noted that in some situations, a customer may already use optimal equipment. At 408, the system determines whether the customer needs new equipment. In this regard, needing new equipment can indicate that the customer does not already have equipment, or that the customer possesses, or is using, potentially suboptimal equipment. Similarly, at 410, the system can determine existing services based on the customer request. At 412, the system can determine whether the customer needs new service(s). In this regard, needing new services can indicate that the customer does not already have services, or that the customer is using potentially suboptimal services. At 414, if new equipment and/or services are needed or otherwise recommended, the system can determine a corresponding provider at 416. The provider can comprise the customer's existing provider, a provider associated with the system, or a different provider registered to use the system. If new equipment is not needed at 414, the system can proceed to generate a recommendation at 418. At 418, any equipment, service(s), and/or provider recommendations can be generated. It is noted that any such recommendation(s) can consider various customer importance weights associated with the customer request. At 420, the recommendation(s) can be provided to the customer (e.g., using an associate website, over email, via text message, via telephone call, or otherwise provided).

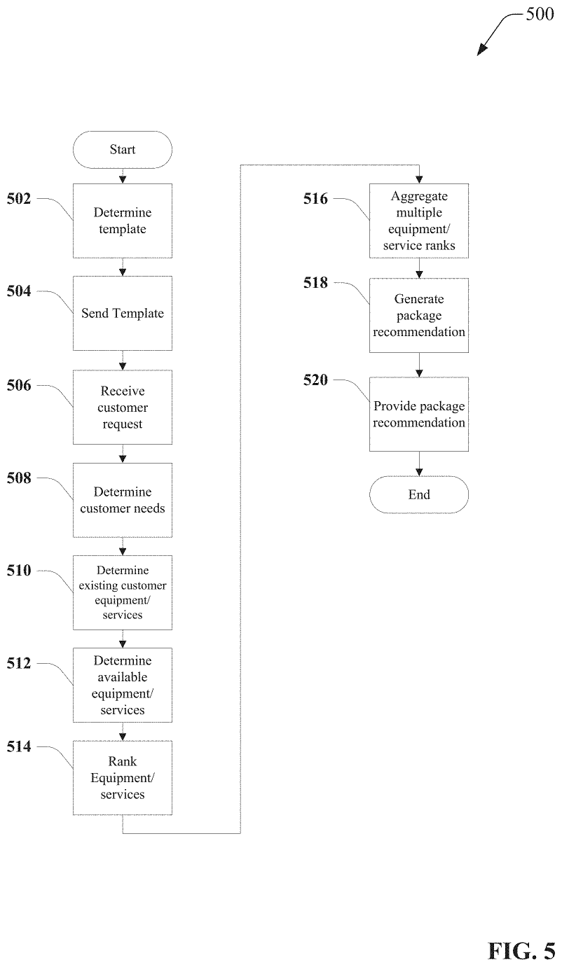

With reference to FIG. 5, there is illustrated a flow chart of a process 500 for providing a recommendation for an equipment and/or service in accordance with one or more embodiments described herein. At 502, the process can comprise determining a template stored in a data store. In this regard, prior to receiving customer input, a template for a customer (e.g., comprising available options, costs, prompts for information such as importance weights, customer location, network needs, requirements, etc.) can be determined based on equipment, services, and/or providers available. At 504, the process can comprise sending the template to a customer. At 506, the process can comprise receiving a customer request. The customer request can comprise a returned template, and can comprise a group of customer requests, the group of customer requests comprising one or more sub-requests. Such requests or sub-requests can comprise one or more requirements associated with a desired network or system, weights, or other information. At 508, customer needs can be determined based on the customer request. At 510, existing customer equipment and/or services (and associated provider(s) can be determined using based on the customer request. At 512, equipment, services, and/or providers that can be made available to the customer are determined. At 514, the available equipment, services, and/or providers can be ranked (e.g., for each request of a group of requests). At 516, the ranks can be aggregated. At 518, an overall service package can be generated using the aggregated ranks. In this regard, a service package can comprise various services and/or components for fulfillment of various sub-requests of the customer request received at 506. At 520, the aforementioned service package can be recommended and/or provided to the customer. It is noted that templates herein can be updated, for instance, using ML based on historical quality ratings associated with past templates.

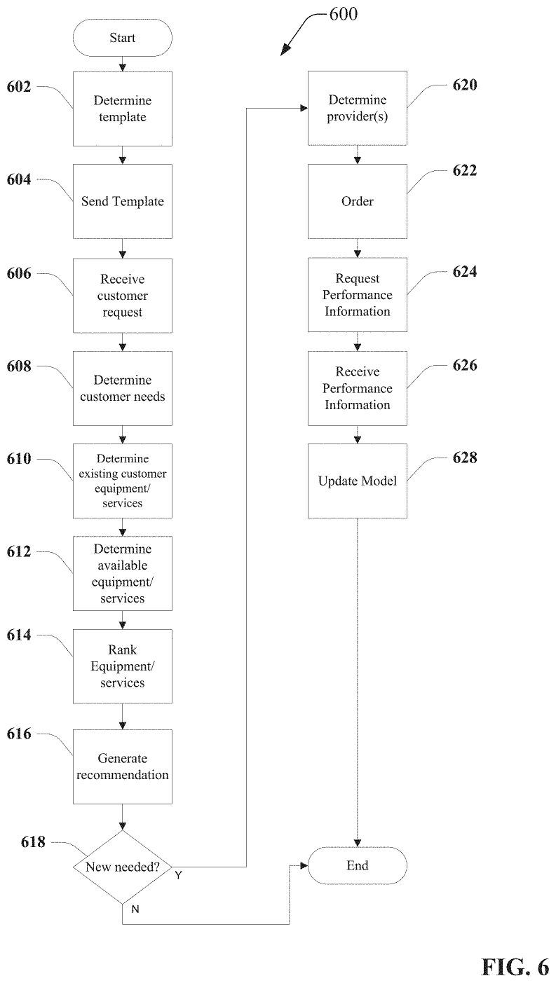

FIG. 6 illustrates a flow chart of a process 600 for providing a recommendation for an equipment and/or service in accordance with one or more embodiments described herein. At 602, the process can comprise determining a template stored in a data store. In this regard, prior to receiving customer input, a template for a customer (e.g., comprising available options, costs, prompts for information such as importance weights, customer location, network needs, requirements, etc.) can be determined based on equipment, services, and/or providers available. At 604, the process can comprise sending the template to a customer. At 606, the process can comprise receiving a customer request. The customer request can comprise a returned template, and can comprise a group of customer requests, the group of customer requests comprising one or more sub-requests. Such requests or sub-requests can comprise one or more requirements associated with a desired network or system, weights, or other information. At 608, customer needs can be determined based on the customer request. At 610, existing customer equipment and/or services (and associated provider(s) can be determined using based on the customer request. At 612, equipment, services, and/or providers that can be made available to the customer are determined. At 614, the available equipment, services, and/or providers can be ranked (e.g., for each request of a group of requests). Based on the rankings, a recommendation can be generated at 616. If at 618, the aforementioned recommendation does not comprise any new equipment, services, and/or providers, the process can end. If at 618, the recommendation does comprise at least one of a new equipment, service, and/or provider, the process can proceed to 620. At 620, an optimal provider or providers can be determined based on provider rankings associated with historical data associated with similar requests (e.g., using a model generated using machine learning). At 622, an order can be automatically generated with the determined provider and can comprise any new services and/or equipment associated with the provider and/or the order. After implementation of the equipment, service, and/or provider entity at the customer site, the process can comprise requesting performance information at 624. Such performance information can comprise cost, system stability (e.g., stability information), on-time information (e.g., on-time rating for implementation of a corresponding system or equipment), bandwidth information, ease of use, or other customer feedback information. Information can be requested, for instance, using email, a postcard, text message, survey, automated telephone call, or other information gathering method. Such surveys can comprise prompts for customers that utilized a corresponding system and/or solution (e.g., service or equipment) to rate the solution based on one or more attributes (e.g., cost, system stability, on-time performance, bandwidth information, ease of use, etc.). At 626, the process can comprise receiving such performance information requested at 624. At 628, a model utilized to determine optimal equipment, services, and/or providers can be updated (e.g., using machine learning) based on the performance information received from the customer.

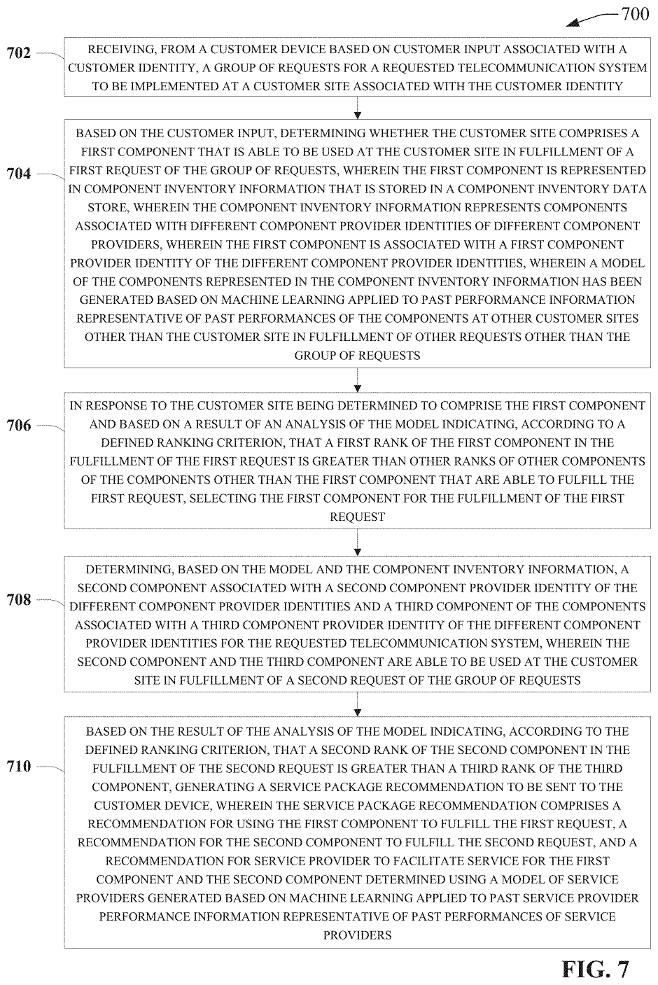

FIG. 7 illustrates a block flow diagram for a process 700 for generating a product/service recommendation in accordance with one or more embodiments described herein. At 702, a group of requests for a requested telecommunication system to be implemented at a customer site associated with the customer identity can be received from a customer device based on customer input associated with a customer identity. At 704, based on the customer input, whether the customer site comprises a first component that is able to be used at the customer site in fulfillment of a first request of the group of requests can be determined, wherein the first component is represented in component inventory information that is stored in a component inventory data store, wherein the component inventory information represents components associated with different component provider identities of different component providers, wherein the first component is associated with a first component provider identity of the different component provider identities, wherein a model of the components represented in the component inventory information has been generated based on machine learning applied to past performance information representative of past performances of the components at other customer sites other than the customer site in fulfillment of other requests other than the group of requests. At 706, the first component for the fulfillment of the first request can be selected in response to the customer site being determined to comprise the first component and based on a result of an analysis of the model indicating, according to a defined ranking criterion, that a first rank of the first component in the fulfillment of the first request is greater than other ranks of other components of the components other than the first component that are able to fulfill the first request. At 708, a second component associated with a second component provider identity of the different component provider identities and a third component of the components associated with a third component provider identity of the different component provider identities for the requested telecommunication system can be determined, based on the model and the component inventory information, wherein the second component and the third component are able to be used at the customer site in fulfillment of a second request of the group of request. At 710, based on the result of the analysis of the model indicating, according to the defined ranking criterion, that a second rank of the second component in the fulfillment of the second request is greater than a third rank of the third component, the process 700 can comprise generating a service package recommendation to be sent to the customer device, wherein the service package recommendation comprises a recommendation for using the first component to fulfill the first request, a recommendation for the second component to fulfill the second request, and a recommendation for service provider to facilitate service for the first component and the second component determined using a model of service providers generated based on machine learning applied to past service provider performance information representative of past performances of service providers.

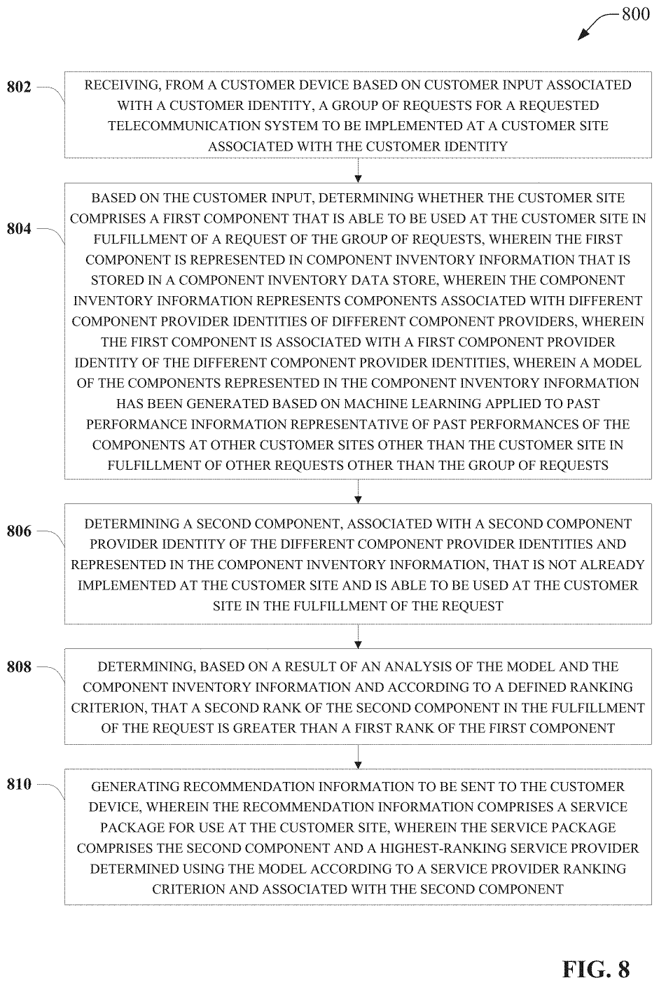

FIG. 8 illustrates a block flow diagram for a process 800 for generating a product/service recommendation in accordance with one or more embodiments described herein. At 802, a group of requests for a requested telecommunication system to be implemented at a customer site associated with a customer identity can be received from the customer device based on customer input associated with a customer identity. At 804, based on the customer input, whether the customer site comprises a first component that is able to be used at the customer site in fulfillment of a request of the group of requests can be determined, wherein the first component is represented in component inventory information that is stored in a component inventory data store, wherein the component inventory information represents components associated with different component provider identities of different component providers, wherein the first component is associated with a first component provider identity of the different component provider identities, wherein a model of the components represented in the component inventory information has been generated based on machine learning applied to past performance information representative of past performances of the components at other customer sites other than the customer site in fulfillment of other requests other than the group of requests. At 806, a second component, associated with a second component provider identity of the different component provider identities and represented in the component inventory information, that is not already implemented at the customer site and is able to be used at the customer site in the fulfillment of the request cam ne determined. At 808, a second rank of the second component in the fulfillment of the request can be determined to be greater than a first rank of the first component based on a result of an analysis of the model and the component inventory information and according to a defined ranking criterion. At 810, the process 800 can comprise generating recommendation information to be sent to the customer device, wherein the recommendation information comprises a service package for use at the customer site, wherein the service package comprises the second component and a highest-ranking service provider determined using the model according to a service provider ranking criterion and associated with the second component.

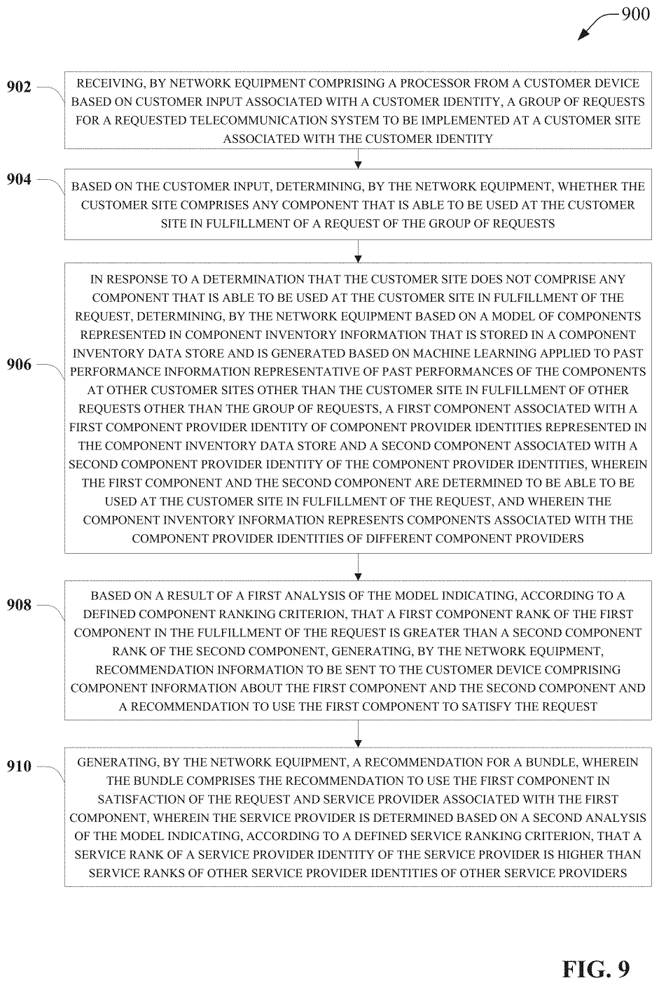

FIG. 9 illustrates a block flow diagram for a process 900 for generating a product/service recommendation in accordance with one or more embodiments described herein. At 902, the process 900 can comprise receiving, by network equipment comprising a processor from a customer device based on customer input associated with a customer identity, a group of requests for a requested telecommunication system to be implemented at a customer site associated with the customer identity. At 904, the process 900 can comprise based on the customer input, determining, by the network equipment, whether the customer site comprises any component that is able to be used at the customer site in fulfillment of a request of the group of requests. At 906, the process 900 can comprise in response to a determination that the customer site does not comprise any component that is able to be used at the customer site in fulfillment of the request, determining, by the network equipment based on a model of components represented in component inventory information that is stored in a component inventory data store and is generated based on machine learning applied to past performance information representative of past performances of the components at other customer sites other than the customer site in fulfillment of other requests other than the group of requests, a first component associated with a first component provider identity of component provider identities represented in the component inventory data store and a second component associated with a second component provider identity of the component provider identities, wherein the first component and the second component are determined to be able to be used at the customer site in fulfillment of the request, and wherein the component inventory information represents components associated with the component provider identities of different component providers. At 908, the process 900 can comprise based on a result of a first analysis of the model indicating, according to a defined component ranking criterion, that a first component rank of the first component in the fulfillment of the request is greater than a second component rank of the second component, generating, by the network equipment, recommendation information to be sent to the customer device comprising component information about the first component and the second component and a recommendation to use the first component to satisfy the request. At 910, the process 900 can comprise generating, by the network equipment, a recommendation for a bundle, wherein the bundle comprises the recommendation to use the first component in satisfaction of the request and service provider associated with the first component, wherein the service provider is determined based on a second analysis of the model indicating, according to a defined service ranking criterion, that a service rank of a service provider identity of the service provider is higher than service ranks of other service provider identities of other service providers.

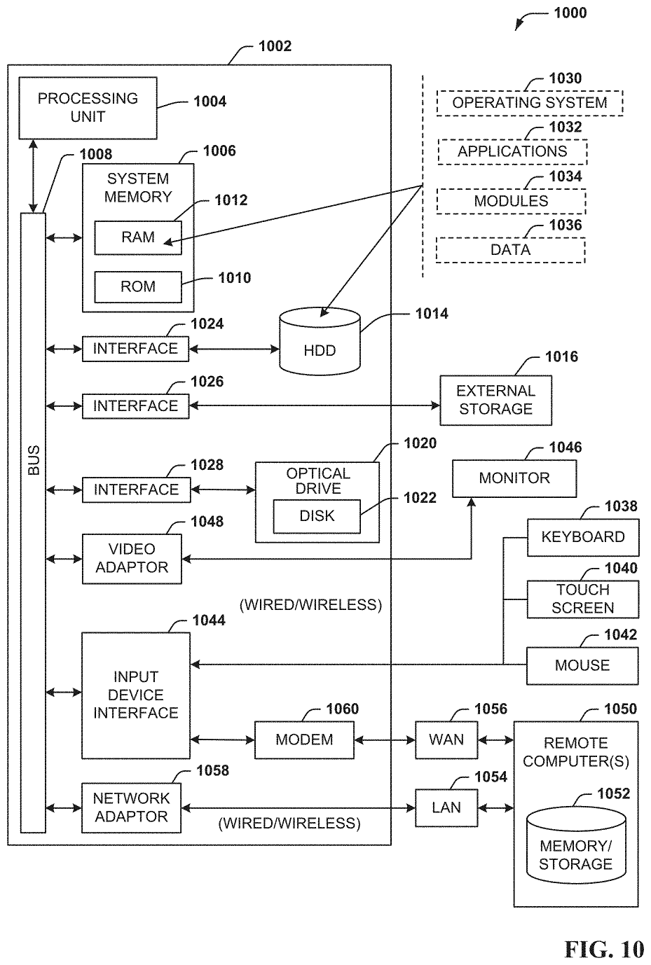

In order to provide additional context for various embodiments described herein, FIG. 10 and the following discussion are intended to provide a brief, general description of a suitable computing environment 1000 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 10, the example environment 1000 for implementing various embodiments of the aspects described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a non-volatile memory such as ROM, erasable programmable read only memory (EPROM), EEPROM, which BIOS contains the basic routines that help to transfer information between elements within the computer 1002, such as during startup. The RAM 1012 can also include a high-speed RAM such as static RAM for caching data.

The computer 1002 further includes an internal hard disk drive (HDD) 1014 (e.g., EIDE, SATA), one or more external storage devices 1016 (e.g., a magnetic floppy disk drive (FDD) 1016, a memory stick or flash drive reader, a memory card reader, etc.) and an optical disk drive 1020 (e.g., which can read or write from a CD-ROM disc, a DVD, a BD, etc.). While the internal HDD 1014 is illustrated as located within the computer 1002, the internal HDD 1014 can also be configured for external use in a suitable chassis (not shown). Additionally, while not shown in environment 1000, a solid-state drive (SSD) could be used in addition to, or in place of, an HDD 1014. The HDD 1014, external storage device(s) 1016 and optical disk drive 1020 can be connected to the system bus 1008 by an HDD interface 1024, an external storage interface 1026 and an optical drive interface 1028, respectively. The interface 1024 for external drive implementations can include at least one or both of Universal Serial Bus (USB) and Institute of Electrical and Electronics Engineers (IEEE) 1694 interface technologies. Other external drive connection technologies are within contemplation of the embodiments described herein.

The drives and their associated computer-readable storage media provide nonvolatile storage of data, data structures, computer-executable instructions, and so forth. For the computer 1002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can comprise one virtual machine (VM) of multiple VMs hosted at computer 1002. Furthermore, operating system 1030 can provide runtime environments, such as the Java runtime environment or the .NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can be enable with a security module, such as a trusted processing module (TPM). For instance, with a TPM, boot components hash next in time boot components, and wait for a match of results to secured values, before loading a next boot component. This process can take place at any layer in the code execution stack of computer 1002, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 13104 serial port, a game port, a USB port, an IR interface, a BLUETOOTH® interface, etc.

A monitor 1046 or other type of display device can be also connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired and/or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 and/or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 can be connected to the local network 1054 through a wired and/or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the Internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. It will be appreciated that the network connections shown are example and other means of establishing a communications link between the computers can be used.

When used in either a LAN or WAN networking environment, the computer 1002 can access cloud storage systems or other network-based storage systems in addition to, or in place of, external storage devices 1016 as described above. Generally, a connection between the computer 1002 and a cloud storage system can be established over a LAN 1054 or WAN 1056 e.g., by the adapter 1058 or modem 1060, respectively. Upon connecting the computer 1002 to an associated cloud storage system, the external storage interface 1026 can, with the aid of the adapter 1058 and/or modem 1060, manage storage provided by the cloud storage system as it would other types of external storage. For instance, the external storage interface 1026 can be configured to provide access to cloud storage sources as if those sources were physically connected to the computer 1002.

The computer 1002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

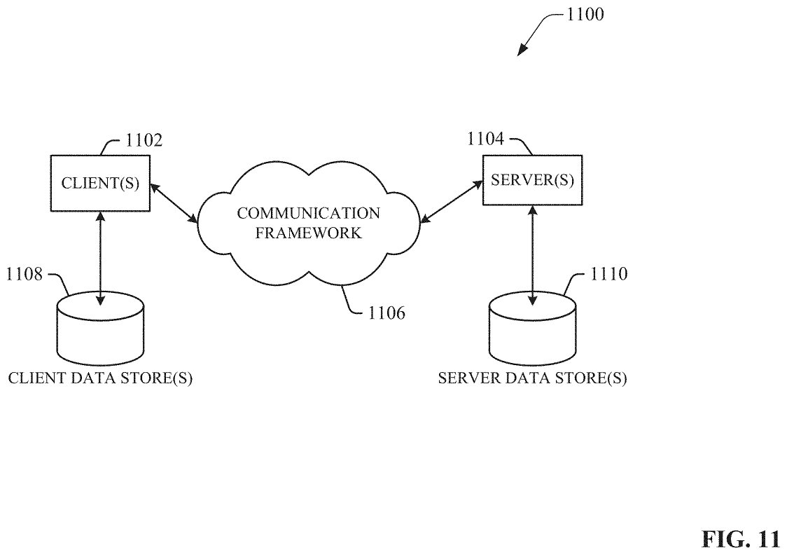

Referring now to FIG. 11, there is illustrated a schematic block diagram of a computing environment 1100 in accordance with this specification. The system 1100 includes one or more client(s) 1102, (e.g., computers, smart phones, tablets, cameras, PDA's). The client(s) 1102 can be hardware and/or software (e.g., threads, processes, computing devices). The client(s) 1102 can house cookie(s) and/or associated contextual information by employing the specification, for example.

The system 1100 also includes one or more server(s) 1104. The server(s) 1104 can also be hardware or hardware in combination with software (e.g., threads, processes, computing devices). The servers 1104 can house threads to perform transformations of media items by employing aspects of this disclosure, for example. One possible communication between a client 1102 and a server 1104 can be in the form of a data packet adapted to be transmitted between two or more computer processes wherein data packets may include coded analyzed headspaces and/or input. The data packet can include a cookie and/or associated contextual information, for example. The system 1100 includes a communication framework 1106 (e.g., a global communication network such as the Internet) that can be employed to facilitate communications between the client(s) 1102 and the server(s) 1104.

Communications can be facilitated via a wired (including optical fiber) and/or wireless technology. The client(s) 1102 are operatively connected to one or more client data store(s) 1108 that can be employed to store information local to the client(s) 1102 (e.g., cookie(s) and/or associated contextual information). Similarly, the server(s) 1104 are operatively connected to one or more server data store(s) 1110 that can be employed to store information local to the servers 1104.

In one exemplary implementation, a client 1102 can transfer an encoded file, (e.g., encoded media item), to server 1104. Server 1104 can store the file, decode the file, or transmit the file to another client 1102. It is noted that a client 1102 can also transfer uncompressed file to a server 1104 and server 1104 can compress the file and/or transform the file in accordance with this disclosure. Likewise, server 1104 can encode information and transmit the information via communication framework 1106 to one or more clients 1102.

The illustrated aspects of the disclosure may also be practiced in distributed computing environments where certain tasks are performed by remote processing devices that are linked through a communications network. In a distributed computing environment, program modules can be located in both local and remote memory storage devices.

The above description includes non-limiting examples of the various embodiments. It is, of course, not possible to describe every conceivable combination of components or methods for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above-described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

1. Network equipment, comprising:
a processor; and
a memory that stores executable instructions that, when executed by the processor, facilitate performance of operations, comprising:
receiving, from a customer device based on customer input associated with a customer identity, a group of requests for a requested telecommunication system to be implemented at a customer site associated with the customer identity;
based on the customer input, determining whether the customer site comprises a first component that is able to be used at the customer site in fulfillment of a first request of the group of requests, wherein the first component is represented in component inventory information that is stored in a component inventory data store, wherein the component inventory information represents components associated with different component provider identities of different component providers, wherein the first component is associated with a first component provider identity of the different component provider identities, wherein a model of the components represented in the component inventory information has been generated based on machine learning applied to past performance information representative of past performances of the components at other customer sites other than the customer site in fulfillment of other requests other than the group of requests;
in response to the customer site being determined to comprise the first component and based on a result of an analysis of the model indicating, according to a defined ranking criterion, that a first rank of the first component in the fulfillment of the first request is greater than other ranks of other components of the components other than the first component that are able to fulfill the first request, selecting the first component for the fulfillment of the first request;
determining, based on the model and the component inventory information, a second component associated with a second component provider identity of the different component provider identities and a third component of the components associated with a third component provider identity of the different component provider identities for the requested telecommunication system, wherein the second component and the third component are able to be used at the customer site in fulfillment of a second request of the group of requests; and
based on the result of the analysis of the model indicating, according to the defined ranking criterion, that a second rank of the second component in the fulfillment of the second request is greater than a third rank of the third component, generating a service package recommendation to be sent to the customer device, wherein the service package recommendation comprises a recommendation for using the first component to fulfill the first request, a recommendation for the second component to fulfill the second request, and a recommendation for service provider to facilitate service for the first component and the second component determined using a model of service providers generated based on machine learning applied to past service provider performance information representative of past performances of service providers.

2. The network equipment of claim 1, wherein the operations further comprise:
receiving the customer input via a user interface rendered at the customer device associated with the customer identity.

3. The network equipment of claim 2, wherein the operations further comprise:
sending the service package recommendation to the customer device, the service package recommendation on comprising:
first component information representative of the first component,
the first rank associated with the first component,
second component information representative of the second component,
the second rank associated with the second component,
third component information representative of the third component,
the third rank associated with the third component,
a recommendation to use the first component for the first request and the second component for the second request.

4. The network equipment of claim 2, wherein the operations further comprise:
determining a template for the components stored in the component inventory data store; and
prior to receiving the customer input, sending information to the customer device for presentation of the template via the user interface.

5. The network equipment of claim 1, wherein the group of requests comprises a location of the customer site.

6. The network equipment of claim 5, wherein the second component and the third component are determined to be available to be provided at the location.

7. The network equipment of claim 1, wherein the operations further comprise:
determining, using the model, weights for the group of requests, wherein the first rank, the second rank, and the third rank are based on respective weights, of the weights, for the first request and the second request.

8. The network equipment of claim 1, wherein the customer device associated with the customer identity is a first customer device associated with a first customer identity, wherein the group of requests is a first group of requests, and wherein the operations further comprise:
after implementation of the second component at the customer site, receiving performance information relating to a performance of the second component at the customer site; and
updating the model of the components based on the performance information resulting in an updated model to be used for future analysis of a second group of requests received in the future from a second customer device associated with a second customer identity different than the first customer identity.

9. The network equipment of claim 8, wherein the performance information comprises stability information representative of a stability associated with the implementation of the second component as compared to stabilities associated with prior implementations of the second component represented in the past performance information.

10. The network equipment of claim 8, wherein the performance information comprises on-time information representative of an amount of time from an order of the implementation of the second component to completion of the implementation of the second component at the customer site as compared to previous amounts of time from past orders of implementations of the second component to completions of the implementations of the second component represented in the past performance information.

11. The network equipment of claim 8, wherein the performance information comprises bandwidth information representative of a bandwidth resulting from the implementation of the second component as compared to bandwidths resulting from prior implementations of the second component represented in the past performance information.

12. The network equipment of claim 1, wherein the operations further comprise:
in response to the customer site being determined to comprise the first component and based on the result of the analysis of the model indicating, according to the defined ranking criterion, that the first rank of the first component is less than a fourth rank of a fourth component of the other components, selecting the fourth component for the fulfillment of the first request; and
sending the service package recommendation to the customer device, the service package recommendation comprising:
first component information representative of the first component,
the first rank associated with the first component,
second component information representative of the second component,
the second rank associated with the second component,
third component information representative of the third component,
the third rank associated with the third component,
fourth component information representative of the fourth component,
the fourth rank associated with the fourth component,
a recommendation to use the fourth component for the first request and the second component for the second request.

13. The network equipment of claim 1, wherein the second component provider identity and the third component provider identity are different identities.

14. The network equipment of claim 1, wherein the defined ranking criterion comprises a criterion relating to a cost of component implementation.

15. The network equipment of claim 1, wherein the defined ranking criterion comprises a criterion relating to an amount of time consumed for component implementation.

16. A non-transitory machine-readable medium, comprising executable instructions that, when executed by a processor, facilitate performance of operations, comprising:
receiving, from a customer device based on customer input associated with a customer identity, a group of requests for a requested telecommunication system to be implemented at a customer site associated with the customer identity;
based on the customer input, determining whether the customer site comprises a first component that is able to be used at the customer site in fulfillment of a request of the group of requests, wherein the first component is represented in component inventory information that is stored in a component inventory data store, wherein the component inventory information represents components associated with different component provider identities of different component providers, wherein the first component is associated with a first component provider identity of the different component provider identities, wherein a model of the components represented in the component inventory information has been generated based on machine learning applied to past performance information representative of past performances of the components at other customer sites other than the customer site in fulfillment of other requests other than the group of requests;
determining a second component, associated with a second component provider identity of the different component provider identities and represented in the component inventory information, that is not already implemented at the customer site and is able to be used at the customer site in the fulfillment of the request;
determining, based on a result of an analysis of the model and the component inventory information and according to a defined ranking criterion, that a second rank of the second component in the fulfillment of the request is greater than a first rank of the first component; and generating recommendation information to be sent to the customer device, wherein the recommendation information comprises a service package for use at the customer site, wherein the service package comprises the second component and a highest-ranking service provider determined using the model according to a service provider ranking criterion and associated with the second component.

17. The non-transitory machine-readable medium of claim 16, wherein the operations further comprise:
after implementation of the second component at the customer site, receiving performance information relating to a performance of the second component at the customer site; and
updating the model of the components based on the performance information resulting in an updated model to be used for future analysis of groups of requests received in the future from different customer devices associated with different customer identities other than the customer identity.

18. The non-transitory machine-readable medium of claim 17, wherein the performance information comprises customer opinion information representative of an opinion, associated with the customer identity, about the implementation of the second component at the customer site, and wherein the operations further comprise:
based on the customer opinion information, determining a numerical feedback score corresponding to the customer opinion information using an artificial intelligence analysis to convert the customer opinion information to the numerical feedback score, wherein updating the model of the components comprises updating the model of the components based on the numerical feedback score.

19. A method, comprising:
receiving, by network equipment comprising a processor from a customer device based on customer input associated with a customer identity, a group of requests for a requested telecommunication system to be implemented at a customer site associated with the customer identity;
based on the customer input, determining, by the network equipment, whether the customer site comprises any component that is able to be used at the customer site in fulfillment of a request of the group of requests;
in response to a determination that the customer site does not comprise any component that is able to be used at the customer site in fulfillment of the request, determining, by the network equipment based on a model of components represented in component inventory information that is stored in a component inventory data store and is generated based on machine learning applied to past performance information representative of past performances of the components at other customer sites other than the customer site in fulfillment of other requests other than the group of requests, a first component associated with a first component provider identity of component provider identities represented in the component inventory data store and a second component associated with a second component provider identity of the component provider identities, wherein the first component and the second component are determined to be able to be used at the customer site in fulfillment of the request, and wherein the component inventory information represents components associated with the component provider identities of different component providers;
based on a result of a first analysis of the model indicating, according to a defined component ranking criterion, that a first component rank of the first component in the fulfillment of the request is greater than a second component rank of the second component, generating, by the network equipment, recommendation information to be sent to the customer device comprising component information about the first component and the second component and a recommendation to use the first component to satisfy the request; and
generating, by the network equipment, a recommendation for a bundle, wherein the bundle comprises the recommendation to use the first component in satisfaction of the request and service provider associated with the first component, wherein the service provider is determined based on a second analysis of the model indicating, according to a defined service ranking criterion, that a service rank of a service provider identity of the service provider is higher than service ranks of other service provider identities of other service providers.

20. The method of claim 19, wherein a component of the components comprises a software defined wide area network.
